(19) United States
(12) Patent Application Publication
(10) Pub. No.: US 2002/0107789 A1
(43) Pub. Date: Aug. 8, 2002

(54) Data processing system for initiating and administering financial products

(76) Inventor: Jocelyn Tristram Gervais Wood, London (GB)

Correspondence Address: ST. ONGE STEWARD JOHNSTON & REENS, LLC, 986 BEDFORD STREET, STAMFORD, CT, 06905-5619, US

(21) Appl. No.: 09/933,090

(22) Filed: Aug. 20, 2001

Related U.S. Application Data
(63) Continuation of application No. PCT/GB00/00596, filed on Feb. 18, 2000.

(30) Foreign Application Priority Data
Feb. 18, 1999 (GB) 9903766.5

(51) Int. Cl. G06F 17/60

(52) U.S. Cl. 705/38; 705/36

(57) ABSTRACT

This invention relates to the field of finance and relates particularly to a method and data processing system for initiating and administering a long term loan. The object of the present invention is to provide a data processing system for initiating and administering an income bonded loan which overcomes the disadvantages of the conventional prior art methods. This invention provides an operatively interconnected data processing system for producing and administering an income bonded loan wherein the whole or part of the compensation paid for the use of the funds is repaid by a predetermined percentage of future income rather than by an interest rate whether fixed or variable.

This application is a continuation of pending International Application PCT/GB00/00596 filed Feb. 18, 2000, which designates the United States and claims priority of GB9903766.5 filed Feb. 18, 1999.

This invention relates to the field of finance and relates particularly to a method and data processing system for initiating and administering a range of financial products.

The financial services industry provides products with a wide range of payment characteristics. The mortgage market alone offers a bewildering variety of products to satisfy the long term personal debt needs of home owners. The prior art and problems of this loan industry and the financial management systems which support it are well described in U.S. Pat. No. 5,742,775. Essentially there are two processes used for transferring money from lender to borrower, debt and equity. Equity is unsuited to consumer credit, leaving debt as the only borrowing process available. The present invention provides a third process, one that is suitable for the consumer credit market but which exhibits characteristics of both the debt and equity processes and is thus suitable for implementation across the financial services industry including the provision of pensions and savings. One characteristic of all personal lending products is the payment of compensation for the use of the funds which the borrower receives from the lender. This compensation has hitherto been determined by reference to a quoted interest rate which may be fixed or variable.

There are many problems inherent in this loan compensation process for borrowers. For example, the amount of the loan is determined by the borrower's ability to repay the loan interest from current income. This means that the loan amount is based on the income in the first period of the loan and not on the income which will be earned over the lifetime of the loan. Furthermore, the loan repayments generally reduce as a percentage of the borrower's income over time which means that loan repayments are a high proportion of income when the income level is at the lowest point in the loan term and low when the absolute value of the income is likely to be highest, which means that the borrower is more likely to suffer hardship early in the repayment schedule. In addition, repayments are usually subject to the variability of interest rates making it difficult for an individual to estimate the affordability of long term debt. Fixed interest loans generally include a premium to compensate the lender for the increased risk associated with them over a long period and are thus more expensive. A major problem for the borrower is that if his or her income should fall significantly for a period of time, the loan repayments will generally remain at the same level leading to financial hardship or possibly default and, in the case of a mortgage, repossession of the family home.

The problems inherent in this type of loan are not limited to the borrower. Lenders must protect themselves from the risks of making the loan, and hedging against interest rate fluctuations is expensive and normally related to equity, bond or derivative financial instruments which may have a higher risk premium than a secured loan or provide a lower return. Furthermore, loans are subject to high default rates during adverse economic conditions. In addition, the value of future loan repayments must be discounted by the erosive effects of inflation as measured by the Retail Prices Index for example.

Attempts to securitize mortgages for the UK financial market have not proved successful, this results in low levels of liquidity and hence higher risk for lending organisations which specialise in the provision of mortgages and other long term personal debt.

The object of the present invention is to provide an alternative industrial process implemented on a data processing system for initiating and administering a range of financial products, particularly an income bonded loan which overcomes the disadvantages of the conventional prior art processes. This process forms a third industrial process within the financial services industry alongside debt and equity and provides an alternative to purely debt based borrowing.

This invention provides an operatively interconnected data processing system for initiating and administering a range of financial products wherein the compensation for the use of funds is repaid by a predetermined percentage of future income rather than by an interest rate whether fixed or variable.

According to the present invention there is provided a data processing system for initiating and managing a loan, pension or other financial product where capital is transferred from a lender to a borrower, which loan is to be repaid over a term, which system comprises:

(i) means for logging personal data into a personal database, which data comprises one or more predetermined relevant indicators of the borrower's future income profile;

(ii) means for estimating the borrower's future income, which means comprises a database of reference income profiles for a plurality of borrower categories, each profile individually identifiable by its characteristic reference indicator(s), and means for matching or approximating the relevant indicator(s) with each reference indicator or indicators thereby to arrive at an income profile most suited to the customer for the period of the product;

(iii) means for computing a predicted payment schedule over the period, which schedule comprises a plurality of predicted payment events, the amount to be paid at each event being calculated as a percentage value of the customer's estimated instantaneous income at about the time that the repayment is to be made; the system further comprising;

(iv) means for logging the customer's actual income during the term of the contract and demanding payment events from the customer, each payment comprising the predicted percentage value of the borrower's actual income rather than the predicted income, whereby the actual payment comprises a proportion of the borrower's actual income during the period of the contract.

In an embodiment of the invention used to produce a loan, the percentage value predicted to be repaid may be calculated to repay the loan compensation while the capital portion is repaid by a separate financial instrument.

Alternatively, the percentage value predicted to be repaid may be calculated to repay both the capital and compensation during the term.

The compensation to be repaid may be adjusted over the term according to any known economic prediction model or forecast which is made when actual repayments have been made.

In one aspect of the invention, the percentage of the borrower's income forming a repayment at each payment event may be a fixed percentage during the term of the loan.

In another aspect of the invention the percentage of the borrower's income forming a repayment at any payment event may vary according to the contract. For example, the percentage may be adjusted up or down during the loan period as a predefined event or as a response to a set of predefined circumstances.

The reference database may comprise data indicative of the probability of variation from the predicted income profile for each borrower category, the percentage value or total amount to be repaid being adjusted to increase where the probability of variation increases, thereby compensating for perceived risk.

In an embodiment of the invention used to produce a pension or other savings product in addition to the loan, the predicted payments may be used to establish a fund, administered according to the contract, which pays in one aspect a lump sum, in another aspect an income, which is predefined either as an absolute value or as a function of an absolute value and one or more economic indicators. For example, the percentage payments produce a fund which pays an annuity equal to a multiple of the customer's initial income adjusted for inflation as measured by the Retail Price Index plus one percent.

The actual income may consist of taxable income or income after tax, or may exclude income subject to specified taxes such as inheritance tax.

The actual payments may be subject to a ceiling and/or floor thereby to provide maximum and/or minimum payments at the payment events, or banded, thereby producing a ceiling which will limit the maximum payments for loan compensation purposes and establish an start level at which payments are made into a pension or savings plan, and a floor which will establish a limit to the minimum payment value and trigger the draw down of previous payments above the ceiling to make up the shortfall between the actual level of percentage repayments and the minimum level of payments specified in the band.

Preferably the data processing system may comprise a computer or computer network programmed to carry out the calculations required and to store the data required.

The present invention provides a process for producing financial products which: in the embodiment of an income bonded loan will allow borrowers to access their future income whilst insulating them from interest rate volatility and providing the security offered by the knowledge that whether their income rises or falls their loan repayments will remain at a predetermined percentage of income; and in the embodiment of an income bonded pension or savings plan will allow savers to guarantee the future value of their savings regardless of the amount which they actually contribute to the plan. Financial product retailers will receive payments which are only weakly linked to interest rates and which are likely to grow faster than the rate of inflation and pay inflation, thus acting as a hedge against the interest rate volatility and/or uncertain returns on equity of their other investments.

The main advantages of the invention for the customer are:

The loan amount can be based on the whole income which is expected to be earned over the loan period, not current income alone.

Loan repayments can be predictable as a percentage of income over the life of the loan so they will always be affordable.

The customer can be insulated from the effects of the economic cycle.

A pension or savings plan may be combined with the loan with the proceeds predefined in such a way that they are also protected against adverse economic conditions.

The main advantages of the invention for the financial product provider are:

The payments received are likely to outperform inflation and pay inflation and are as a result likely to be particularly attractive to providers of pensions and annuities.

The payments will generally increase when interest rates fall and decrease when interest rates rise thus providing a useful hedge facility.

The characteristics of the income bonded loan which make it suitable as a hedge against interest rates offer an improved opportunity for the securitization of the loans and thus provide improved liquidity and hence lower risk for the lending institution.

The capital repayments may be made as part of the income percentage repayments or a separate financial instrument may be used or the amount may be amortized over the loan period.

The income on which repayments are based may be defined in several ways, for example; that income which is subject to one or more taxes or that income which remains after income taxes are deducted. The predetermined percentage of income is not necessarily fixed at one level for the entire loan period; for example the contract may stipulate that the borrower repays 20% of income in the first five years, 15% in the second five years and 10% for the last five years of a fifteen year loan.

The loan compensation may be established as a combination of interest rate determined payments and repayments by percentage of income.

A ceiling and floor to the repayments may be set, or a band of repayments may be used whereby for example if income reduces below or increases above a predetermined level the loan repayments remain at a constant value.

The loan may be secured against an asset or assets.

When a sufficient number of loans have been made the lender may securitize the loan repayments for sale and resale on the primary and secondary financial markets.

The loan may be combined with a pension or other investment vehicle, preferably by increasing the percentage of income which is paid to the lender. The amount which is devoted to the investment may be fixed or variable depending upon whether the compensation repayments are within the floor and ceiling band established in the contract. For example, if the compensation repayments fall below the agreed floor, the lender may draw income from the investment in order to make up the difference, or if the loan compensation goes above the agreed ceiling the lender will add the excess to the investment plan. This embodiment of the invention has the additional benefits of reducing risk for the lender and providing a high probability of a lump sum or pension at the end of the loan period for the borrower.

In the drawings:

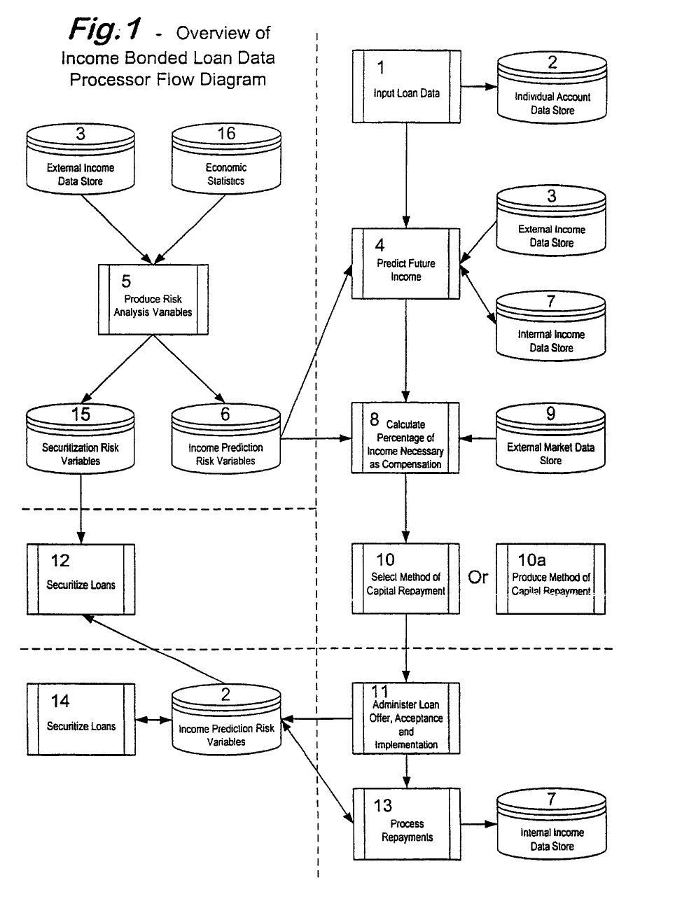

FIG. 1 is a flow diagram showing the tasks to be carried out by a data processing system in performing an embodiment of the present invention.

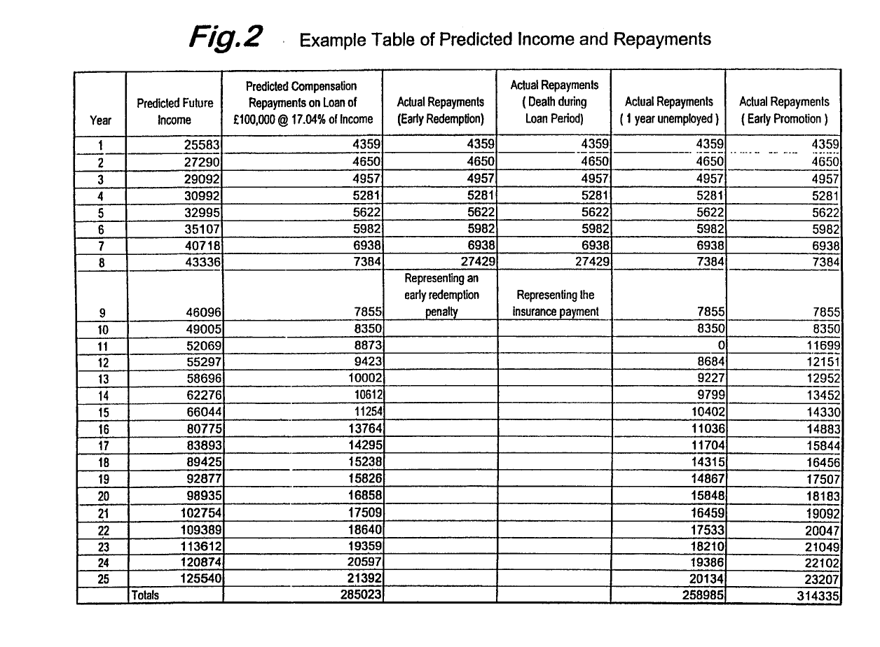

FIG. 2 is a table showing a predicted income profile and repayment schedule, along with examples of actual repayment events.

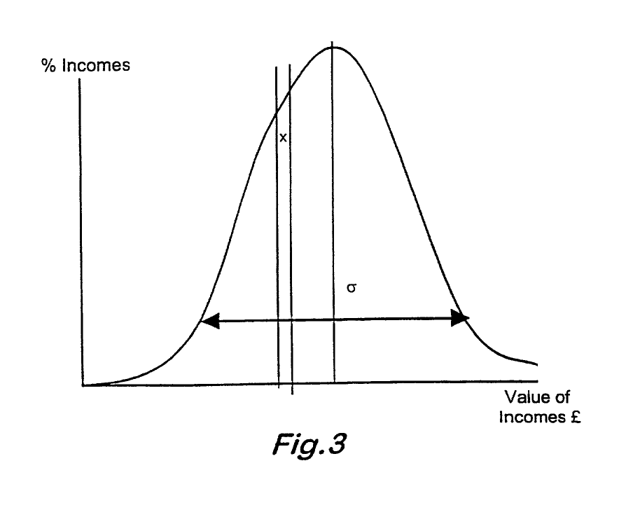

FIG. 3 is a graph showing a distribution of incomes at a particular period forming an element of actual income profiles in a particular employment category.

On application for a loan an individual is assessed and a prediction of his or her future income is made. The repayments necessary to provide compensation for the loan are calculated based on the repayment of the debt at a predetermined percentage of future income. The percentage may change over the course of the loan but must be fixed at the outset although the contract may permit subsequent review of this percentage under predefined circumstances.

An offer is made to the borrower who contracts to repay an agreed percentage of income as compensation for the use of the funds to be lent. A separate financial instrument may be set up to repay the capital. If the borrower accepts the provisional offer, the details which he or she has submitted are verified and a credit check using a credit reference agency would likely be carried out. If all is in order the loan amount is paid to the borrower who then starts to make repayments based on the agreed repayment schedule.

The income based repayments are reviewed at regular intervals to ensure that the correct amount of money is being repaid. This may take the form of an annual submission of a copy of the individual's income tax return. If the individual has no income for a period then no repayments are made unless a base repayment figure has been agreed on in the original contract, for example, provision may be built into the lending agreement that household income may be taken into account in calculating repayments. If the individual's income increases by a great amount, there may be repayment ceilings built into the contract to ensure that the loan repayments are not disproportionate to the amount of the original loan. A variety of other risk reduction business methods may be employed in using the invention such as a mixed loan repayment system where part of the compensation is repaid at fixed or variable interest rates and part as a percentage of income.

If the loan capital is repaid early, the loan agreement will make provision for the potential loss suffered by the lender. This may consist of a penalty payment for early redemption, or the retrospective conversion of the loan to one based on a rate of interest at a pre-agreed premium to central bank minimum lending rates or other benchmark financial product.

If the client suffers serious injury or death during the term of the loan a preset table of early redemption payments may be used to determine the due compensation to the lender which may be covered by an insurance policy.

At the end of the agreed loan period income based repayments stop regardless of the value of the repayments made. Should the borrower wish to take out subsequent loans he or she will be able to do so by committing a further percentage of income, although the lending organisations may wish to put a cap on the percentage of income which may be allocated for repayments depending on factors such as the borrower's age.

The lender may securitize the debt and sell the product on the primary financial market. The debt may be securitized in many ways by splitting interest and capital repayments or by predictions of repayments at particular times or by predictions of conversion to other types of financial instrument.

Specific Embodiment.

A hypothetical borrower, “Andrew Smith”, is seeking a loan of £100,000 to purchase a house. The embodiment includes the core elements of the estimate of future income and the repayment of the loan based on a predetermined percentage of the borrower's actual future income. FIG. 1 provides an overview of the data processing which is carried out. In the following description the reference numerals in the figure are referred to by corresponding numbers in brackets.

Step 1.

The loan applicant fills out an application form (1) (various means may be used for this; for example, by telephone, on paper or on the Internet) and provides the following details which are input into the Individual Account Data Store (2): (the lending organisation's method of doing business will determine exactly what details are required for a statistically reliable assessment.)

TABLE 1

| | |
|---|---|
| Name | Andrew Smith |
| Age | 25 |
| Gender | Male |
| Educational qualifications, | BSc Information Technology |
| awarding bodies and grades | Manchester University |
| bodies and grades | 2:2 |
| Address | Officers Mess, Wood Barracks, London |
| Name of employer | British Army |
| Workplace address | 1 Loamshire Regiment Wood Barracks |
| | London |
| Job Title | Captain |
| Category of employment | Armed Forces (Officer) |
| Length of service in current | 3 years |
| employment category | |
| Purpose of loan | House Purchase |
| Security to be offered (if any) | The house to be purchased |
| Loan Required | £100,000 |
| Period of the loan | 25 years |
| Value of the security | £100,000 |
| Other information relevant to | Nil |
| the loan | |

Step 2.

The applicant's details are now compared with an External Income Data Store (3) (the data in this specific example has been extracted from the 1998 Report of The Armed Forces Pay Review Body) in order to predict future income (4) to identify how he compares with his peer group. In this case the peer group is that of Armed Forces (officers) of similar biographical details. A simulated extract is presented here. The applicant's details are in the first row in this example. The comparator data in this case is selected from those at one level above or below the applicant's educational level; degree subject rating; age; employment category and length of service, and at the same level as his geographical location and of the same sex. The income of each comparator is listed in the left hand column. The table lists only a sample of the data which is available. The skilled person will be aware that actual reference datasets will need to be representative of a statistically significant number of records. The relevance of each field in the record is weighted according to its importance as an indicator of future income. Appropriate weighting may be achieved by the production of a computer neural network trained by means of actual raw data comprising a range of indicators. The relevance of each will be apparent from the weighting functions associated with each node and/or path in the network.

TABLE II

| | | | | | | | | | Length of | |
|---|---|---|---|---|---|---|---|---|---|---|
| | | | | | | | | | service in | |
| Income | Education | Sub- | | | | | Loca- | Job | employment | Employment |
| Level | Level | ject | Grade | Establishment | Age | Sex | tion | Title | category | Category |
| 25,000 | Voc 3 | 3 | 3 | 2 | 25 | 1 | 1 | Capt | 36 | 1 |
| 25,000 | Voc 3 | 2 | 3 | 2 | 25 | 1 | 1 | Capt | 36 | 1 |
| 25,000 | Non-Voc 3 | 2 | 3 | 1 | 25 | 1 | 1 | Capt | 36 | 1 |
| 25,000 | Voc 3 | 3 | 2 | 1 | 25 | 1 | 1 | Capt | 36 | 1 |
| 25,000 | Non-Voc 3 | 3 | 3 | 3 | 25 | 1 | 1 | Capt | 36 | 1 |
| 25,000 | Non-Voc 3 | 3 | 3 | 1 | 25 | 1 | 1 | Capt | 36 | 1 |
| 25,000 | Non-Voc 3 | 3 | 3 | 2 | 25 | 1 | 1 | Capt | 36 | 1 |
| 25,000 | Voc 3 | 5 | 3 | 2 | 25 | 1 | 1 | Capt | 36 | 1 |
| 25,000 | Voc 3 | 3 | 3 | 3 | 25 | 1 | 1 | Capt | 36 | 1 |
| 24,500 | Non-Voc 3 | 4 | 3 | 3 | 25 | 1 | 1 | Capt | 36 | 1 |
| 24,500 | Non-Voc 3 | 3 | 2 | 2 | 25 | 1 | 1 | Capt | 28 | 1 |
| 24,500 | Non-Voc 3 | 3 | 3 | 2 | 25 | 1 | 1 | Capt | 28 | 1 |
| 24,500 | Non-Voc 3 | 4 | 3 | 1 | 25 | 1 | 1 | Capt | 28 | 1 |
| 24,500 | Voc 3 | 2 | 3 | 2 | 25 | 1 | 1 | Capt | 28 | 1 |
| 24,500 | Voc 3 | 3 | 3 | 2 | 25 | 1 | 1 | Capt | 28 | 1 |
| 24,500 | Voc 3 | 3 | 3 | 2 | 25 | 1 | 1 | Capt | 28 | 1 |
| 25,500 | Voc 2 | 2 | 2 | 3 | 25 | 1 | 1 | Capt | 36 | 1 |
| 25,500 | Non-Voc 2 | 2 | 2 | 3 | 25 | 1 | 1 | Capt | 36 | 1 |
| 25,500 | Non-Voc 2 | 2 | 2 | 2 | 25 | 1 | 1 | Capt | 36 | 1 |
| 25,500 | Non-Voc 2 | 2 | 2 | 3 | 25 | 1 | 1 | Capt | 36 | 1 |
| 25,500 | Non-Voc 2 | 2 | 2 | 3 | 25 | 1 | 1 | Capt | 36 | 1 |
| 25,500 | Voc 2 | 2 | 2 | 4 | 25 | 1 | 1 | Capt | 36 | 1 |
| 25,500 | Voc 2 | 2 | 2 | 2 | 25 | 1 | 1 | Capt | 36 | 1 |
| 26,000 | Voc 2 | 2 | 2 | 2 | 25 | 1 | 1 | Capt | 42 | 1 |

Step 3.

The data set relating to comparators one year older than the applicant is queried in the same way as Step 2. This process is repeated for the data sets relating to comparators at each age up to the age the applicant will be at the end of the loan period. This data is used to produce, by a statistical analysis, using selected income risk variables (6), an estimated future income profile as shown in table 111 below:

TABLE III

| | Income £ |
|---|---|
| Age | per annum |
| 25 | 25583 |
| 26 | 26276 |
| 27 | 26970 |
| 28 | 27663 |
| 29 | 28357 |
| 30 | 29050 |
| 31 | 32441 |
| 32 | 33244 |
| 33 | 34047 |
| 34 | 34850 |
| 35 | 35653 |
| 36 | 36456 |
| 37 | 37259 |
| 38 | 38062 |
| 39 | 38865 |
| 40 | 45767 |
| 41 | 45767 |
| 42 | 46972 |
| 43 | 46972 |
| 44 | 48176 |
| 45 | 48176 |
| 46 | 49381 |
| 47 | 49381 |
| 48 | 50585 |
| 49 | 50585 |

The statistical analysis may take many forms and will depend on the business methods used by the lending organisation. As an example, the following process may be used in each distinct category:

1. Formulate a data set comprising a distribution of incomes in that category at each period between repayment events. Each distribution shown graphically is likely to resemble the distribution shown in FIG. 3 for each period calculated. This will result in a series of distributions representing the spread of incomes about a median for a particular income profile.

2. Identify the current income of the applicant on the first graph in the income profile series and assign an income percentile to this value.

3. Identify the same percentile for all graphs to produce a predicted income profile for that person.

4. Call the deviation range about the median a risk variable σ.

5. Examine the data set to confirm that all future periods have an acceptable value of σ. σ is the distance from the median income of the graph to a value whereby a line drawn through the graph at that distance on either side of the centre line will encompass a percentage of the individual incomes which is defined in the Income Prediction Risk Variables Data Store (6). Such percentage being an assessment of the size of risk which the lending institution is prepared to accept. As the majority of 25 year old Army officers are paid the same amount of money the σ for this applicant's vocational group is very small indicating a low level of risk. The income of 25 year old commodities traders may have a very large σ indicating that income predictions will be very uncertain and thus of much greater risk.

6. Confirm that the loan applicant's percentile “x” falls within the a range for each graph.

7. Calculate the income volatility (A) over time of the vocational sector using the data in the External Income Data Store (3). The income volatility has three components, Δ₁ which is the uncertainty of an individual income over time; in other words, the extent to which the income location of an individual moves on the graph over time. In this example, which relates to an Army Officer, there is very little uncertainty because his income will not reduce so long as he remains employed by the Army, nor will it increase other than according to the annual and promotion increments which are found in the External Income Data Store (3). The income of a self-employed computer consultant will have a much greater volatility for example since his or her income will be determined by a wider range of uncertain factors); Δ₂ which is the uncertainty associated with the vocational sector over time ie the relative movement of salaries within an industrial sector. For example, the relative value of teachers pay has reduced over the last 25 years in the United Kingdom compared to that of similarly qualified training managers. The third component Δ₃ is the uncertainty associated with the individual remaining within the comparator data set or leaving it. For example by changing industry sector or suffering death or serious injury. This figure is also obtained from the External Income Data Store (3).

8. Confirm that income volatility is within the value of Δ specified in the Income Prediction Risk variables Data Store.

9. Select the maximum acceptable percentile range where the Δ has the lowest value consistent with the risk policy decision held in the Income Prediction Risk Variables Data Store.

10 Establish the average salary of the percentile range for each graph.

11. Tabulate these figures (as in table 1 above) for printed output as part of the Loan Administration Process (11) and store them in the Internal Income Data Store (7).

Step 4.

The next step is to factor in to the estimate of future pay the amount by which actual pay will rise in the future. This information takes the form of two variables: (i) the predicted rate of inflation and (ii) the extent to which pay rises will exceed inflation, both determined by the Risk Analysis Variables Process (5) using data from the Economic Statistics Data Store (16) and extracted from the Income Prediction Risk Variables Data Store (6). The determination of these variables will be the responsibility of the lending organisation and will constitute a professional judgement.

In this case we will use historical data; the average inflation rate as indicated by the UK Retail Price Index over the five years from Jan 94 to Jan 99 (2.69%) and the gap between inflation and rises in average earnings as published by the UK Office of National Statistics over the same period (1.17%). These two variables are added together and used to calculate the predicted future income of the applicant using the standard formula for the future value of £1:

£1=(1+r)ⁿ

Where n is the number of years the income will be received in the future and r is the discount rate, in this case the sum of the two inflation variables; 3.86%.

This produces table IV of predicted future income adjusted for inflation and annual inflation linked pay rises which is stored in the Internal Income Data Store (7):

TABLE IV

| | Income £ |
|---|---|
| Age | per annum |
| 25 | 25583 |
| 26 | 27290 |
| 27 | 29092 |
| 28 | 30992 |
| 29 | 32995 |
| 30 | 35107 |
| 31 | 40718 |
| 32 | 43336 |
| 33 | 46096 |
| 34 | 49005 |
| 35 | 52069 |
| 36 | 55297 |
| 37 | 58696 |
| 38 | 62276 |
| 39 | 66044 |
| 40 | 80775 |
| 41 | 83893 |
| 42 | 89425 |
| 43 | 92877 |
| 44 | 98935 |
| 45 | 102754 |
| 46 | 109389 |
| 47 | 113612 |
| 48 | 120874 |
| 49 | 125540 |

Step 5.

The next step is to calculate the risk discount to be used to establish the present value of the applicant's future income. The risk discount in this case comprises the following factors which are extracted from the Income Prediction Risk Variables Data Store (6) although the model of risk used will be proprietary to the lending organisation:

(i) The Δ

(ii) The σ

(iii) The risk that the applicant will commit fraud or default.

(iv) The risk that the applicant will repay the mortgage early and hence produce the return specified by the early redemption conditions.

(v) The risk that interest rates will be much higher than estimated and hence the returns will be greater than using the income bonded loan system.

The skilled person will be aware that there are many mathematical methods available for calculating these risks and the lending organisation will select the method in which it has most faith. In this example a risk discount of 1% greater than that used for a standard variable interest rate mortgage will be used. The comparator tables used to predict future income in steps 2 and 3 will already have taken into account the possibility of lower or higher than expected repayments. It will be a condition of this loan that it is secured against the property, that life assurance is taken out to the value of future predicted income repayments at the date of death and that early repayment will incur a compensating penalty. Different applicants may have different conditions attached to their loans which will be established in the loan administration process (11). The 1% factor represents the risk discount associated with the introduction of a new financial product to the market.

Step 6.

Having computed the applicant's predicted future income, the percentage of income necessary to compensate for the use of the lender's funds is now computed (8).

The present value of the interest repayments on a standard mortgage (for the same loan sum) offered at a variable interest rate by a major competitor of the lending institution is calculated or extracted from the External Market Data Store (9). The calculations are done using industry standard mathematical techniques.

The present value of the interest repayments on a £100,000 mortgage assuming an average interest rate of 8% and a risk discount rate of 7% are: £93,229.

The percentage of income necessary to provide repayments which have an equal present value to the repayments on the quoted standard mortgage are then computed using the data in the Internal Income Data Store (7): For this customer it is 17.043%. From this the annual repayments necessary to service the debt on a competitive basis, based on the prediction of future income can be calculated. This represents the calculation to establish the price point at which the loan will be offered. The results of these calculations are shown in table V below:

TABLE V

| | Annual | Present Value | IBL annual | Present value |
|---|---|---|---|---|
| | interest | of mortgage | predicted | of IBL annual |
| | repayments | repayments @ | repayments on | repayments @ |
| | on £100,000 | discount rate | £100,000 | discount rate |
| Year | @ 8% | of 7% | @ 17.043% | of 8% |
| 1 | 8000 | 7477 | 4360 | 4037 |
| 2 | 8000 | 6988 | 4651 | 3988 |
| 3 | 8000 | 6530 | 4958 | 3936 |
| 4 | 8000 | 6103 | 5282 | 3882 |
| 5 | 8000 | 5704 | 5623 | 3827 |
| 6 | 8000 | 5331 | 5983 | 3770 |
| 7 | 8000 | 4982 | 6940 | 4049 |
| 8 | 8000 | 4656 | 7386 | 3990 |
| 10 | 8000 | 4067 | 8352 | 3869 |
| 11 | 8000 | 3801 | 8874 | 3806 |
| 12 | 8000 | 3552 | 9424 | 3743 |
| 13 | 8000 | 3320 | 10004 | 3678 |
| 14 | 8000 | 3103 | 10614 | 3614 |
| 15 | 8000 | 2900 | 11256 | 3548 |
| 16 | 8000 | 2710 | 13767 | 4018 |
| 17 | 8000 | 2533 | 14298 | 3864 |
| 18 | 8000 | 2367 | 15241 | 3814 |
| 19 | 8000 | 2212 | 15829 | 3668 |
| 20 | 8000 | 2067 | 16862 | 3618 |
| 21 | 8000 | 1932 | 17512 | 3479 |
| 22 | 8000 | 1806 | 18643 | 3429 |
| 23 | 8000 | 1688 | 19363 | 3298 |
| 24 | 8000 | 1577 | 20601 | 3249 |
| 25 | 8000 | 1474 | 21396 | 3124 |
| Totals | 200,000 | 93229 | 285076 | 93229 |

Clearly the borrower's estimated predicted repayments are expected to be greater under the income bonded loan than under a standard mortgage loan. This extra cost is offset by the lower future value of repayments because of their erosion by inflation, the relatively higher value of the early repayments which are lower in absolute terms than those of the comparable mortgage, and the increased capital gains which the borrower will receive from the probable rise in value of the mortgaged property.

In this example, the borrower may only be able to borrow three times income under a standard mortgage agreement and thus buy a home at a price of £75,000. The difference in value of this home and the home which may be afforded with the income bonded loan assuming a house price inflation rate of 5% over the loan period is c£75,000, substantially offsetting the additional cost of the income bonded loan. An additional benefit which is apparent is that the borrower is expected to pay less than the comparator mortgage in annual repayments for the first nine years of the loan.

Step 7.

In this case the applicant wishes to use an endowment policy to repay the loan capital. The details of the policy are acceptable to the lender who confirms the validity of the policy with the issuer (10). It would be equally possible for Mr Smith to amortize the loan amount over the loan period or to purchase an appropriate financial product from the lender (10a).

Step 8.

The lender makes a conditional offer of a loan (11) of £100,000 to Mr Smith, the principal to be repaid by an endowment policy and the interest to be repaid by monthly payments of 17.043% of Mr Smith's income (in this example the percentage selected is estimated to provide the same return as the comparator mortgage but the lending organisation may add a premium or a discount depending on their marketing policy and business methodology). The loan is conditional upon Mr Smith taking out a life assurance policy sufficient to pay the outstanding balance of the expected income repayments in the event of Mr Smith's death, and on the verification of the details which have been submitted including the valuation of the property on which the principal is secured. In this instance it is agreed that if Mr Smith wishes to repay the loan early he will incur a redemption penalty equivalent to the repayments which would have been made over the term of the loan had he taken out a variable rate mortgage at 1% above the lending institution's standard quoted rate. Such repayments to be compounded at the same rate of interest.

Step 9.

The offer is accepted, the parties sign an agreed contract and the loan amount is transferred to Mr Smith's account (11).

Step 10.

One month after the loan has been agreed Mr Smith makes his first repayment according to the schedule which has been outlined in the contract. The repayments are received (13) and compared against the predicted repayments. Where appropriate the Internal Income Data Store (7) is modified and the Predicted Future Income held in the Individual Account Data Store (2) is updated based on the outcome of the predictions made in the Risk Analysis (5). The repayments continue in line with the predictions made by the lending organisation which verifies his income details annually (14). At the end of the 25 year period Mr Smith receives the title to his house and his obligation to the lender is discharged (11). There are innumerable alternatives to this scenario. The actual repayments which Mr Smith makes might be in line with one of the columns shown in FIG. 2 which postulates several scenarios which might be followed; i.e. early redemption (year 8), death with insurance (at year 8), 1 year's unemployment during the repayment schedule (year 11) and early promotion (year 11)

Step 11.

The lending organisation groups Mr Smith's loan with a statistically significant number of others of similar risk and securitizes the asset (12) through the normal channels in the country of business. In this case the asset is securitized with a number of others as a $200,000,000 10 year bond paying an annual income of 5% according to the variables produced by the risk analysis process (5) and held in the Securitization Risk Variables data store (15). In 10 years' time the second 10 year tranche of bonds within which Mr Smith's mortgage is securitized is sold, this time with a coupon of 10% reflecting the changed market conditions. The final five year maturity bonds are sold at yet a higher price reflecting the increased repayments and lower risk of the underlying asset. These figures are purely for illustration, the coupon and yield are determined by the price the market is prepared to pay for the asset. In an alternative embodiment, the mortgages could be securitized as a 25 year £200,000,000 fund producing a guaranteed income of £8,000,000 per annum guaranteed to increase at the rate of inflation plus 1% annually. The capital to be paid in full at the end of term.

1. A data processing system for initiating and managing a loan, pension or other financial product where capital is transferred from a lender to a borrower, which loan is to be repaid over a term, which system comprises:
(i) means for logging personal data into a personal database, which data comprises one or more predetermined relevant indicators of the borrower's future income profile;
(ii) means for estimating the borrower's future income, which means comprises a database of reference income profiles for a plurality of borrower categories, each profile individually identifiable by its characteristic reference indicator(s), and means for matching or approximating the relevant indicator(s) with each reference indicator or indicators thereby to arrive at an income profile most suited to the customer for the period of the product;
(iii) means for computing a predicted payment schedule over the period, which schedule comprises a plurality of predicted payment events, the amount to be paid at each event being calculated as a percentage value of the customer's estimated instantaneous income at about the time that the repayment is to be made; the system further comprising;
(iv) means for logging the customer's actual income during the term of the contract and demanding payment events from the customer, each payment comprising the predicted percentage value of the borrower's actual income rather than the predicted income, whereby the actual payment comprises a proportion of the borrower's actual income during the period of the contract.

2. A system as claimed in claim 1 wherein the percentage value predicted to be repaid is calculated to repay the compensation while the capital portion is repaid by a separate financial instrument.

3. A system as claimed in claim 1 wherein the percentage value predicted to be repaid is calculated to repay the capital portion during the term while the compensation is repaid by a separate financial instrument.

4. A system as claimed in claim 1 wherein the percentage value predicted to be repaid is calculated to repay both the capital and the compensation during the term.

5. A system as claimed in any preceding claim wherein the capital sum and/or compensation to be repaid is adjusted over the term according to any known economic prediction model or forecast which is made when actual payments have been received.

6. A system as claimed in any preceding claim wherein the percentage of the borrower's income forming a repayment at each payment event is a fixed percentage during the term of the loan.

7. A system as claimed in any of claims 1 to 5 wherein the percentage of the borrower's income forming a repayment event may vary according to a predefined event or set of circumstances.

8. A system as claimed in claim in claim 7 where the percentage is ramped upwards or downwards as a function of the term of the loan.

9. A system as claimed in any preceding claim wherein the reference database comprises data indicative of the probability of variation from the predicted income profile for each borrower category, the percentage value or total amount to be repaid being adjusted to increase where the probability of variance increases, thereby compensating for perceived risk.

10. A system as claimed in any preceding claim wherein the actual income consists of a gross taxable income or that income which is exempted from specific taxes.

11. A system as claimed in any preceding claim wherein the actual repayments may be a subject to a ceiling and/or floor to provide maximum and/or minimum repayments at the repayment events.

12. A system as claimed in any preceding claim wherein the actual repayments may be used to provide a savings plan or pension if a preset repayment ceiling is exceeded.

13. A system as claimed in any preceding claim wherein the actual repayments above the repayment ceiling may be stored to compensate the lender for any future payments which fail to be equal in value to a predetermined repayment floor.

14. A system as claimed in any preceding claim and comprising a computer or computer network programmed to carry out the calculations required and store the data required.
